(19) United States
(12) Patent Application Publication
(10) Pub. No.: US 2010/0236283 A1
(43) Pub. Date: Sep. 23, 2010

(54) Refrigerant Accumulator

(75) Inventors: Joseph Ballet, Bressolles (FR); Thierry Bejoint, Villars les dombes (FR)

Correspondence Address: BACHMAN & LAPOINTE, P.C. (UTC), 900 CHAPEL STREET, SUITE 1201, NEW HAVEN, CT, 06510-2802, US

(73) Assignee: CARRIER CORPORATION, Farmington, CT (US)

(21) Appl. No.: 12/599,749

(22) PCT Filed: May 16, 2007
(86) PCT No.: PCT/US2007/069024

§ 371 Date: Nov. 11, 2009

(51) Int. Cl. F25B 41/00; B01D 53/02

(52) U.S. Cl. 62/513; 96/113

(57) ABSTRACT

A reversible cooling/heating system (20) has an in-line accumulator/dryer unit (74). The accumulator/dryer unit has a body having first and second ports (76, 78). A foraminate conduit (82) is positioned at least partially within the body. A desiccant (80) at least partially surrounds a first portion of the conduit. A pressure-actuated valve is located along the conduit.

### BACKGROUND

The disclosure relates to air conditioning and heat pump systems. More particularly, the disclosure relates to accumulator/dryer units for such systems.

Accumulator and dryer units are well known in the art. One application where accumulators are particularly important is in reversible systems (e.g., a system that may be run as a heat pump in one mode and an air conditioner in another mode). U.S. Pat. No. 6,494,057 and US Patent Application Publication 2006-0053832 A1 (the '832 publication) disclose combined accumulator/dryer units used in a reversible system.

In such a reversible system, first and second heat exchangers serve as a condenser and evaporator, respectively, in the air conditioner mode and as an evaporator and condenser, respectively, in the heat pump mode. The two heat exchangers are often dissimilar, being configured for preferred operation in one of the modes. Due, in part, to this dissimilarity, the combined mass of refrigerant in the two heat exchangers will differ between the modes. It is, accordingly, appropriate to buffer at least this difference in an accumulator. As in non-reversible systems, the accumulator may also serve to buffer smaller amounts associated with changes in operating conditions, and the like.

Nevertheless, there remains room for improvement in the art.

### SUMMARY

One aspect of the disclosure involves an apparatus having a compressor in a first flow path between first and second heat exchange apparatus. A buffer/desiccant unit is in a second flow path between the heat exchange apparatus. The buffer/desiccant unit includes a vessel having first and second ports, a foraminate conduit at least partially within the shell, and a desiccant at least partially surrounding a first portion of the conduit. A pressure-actuated valve is along a second portion of the conduit. One or more valves are positioned to switch the apparatus between first and second modes. In the first mode, refrigerant flows from the second heat exchange apparatus to the first heat exchange apparatus along the second flow path. In the second mode, refrigerant flows from the first heat exchange apparatus to the second heat exchange apparatus along the second flow path.

In various implementations, the first heat exchange apparatus may be a refrigerant-to-water heat exchanger. The second heat exchange apparatus may be a refrigerant-to-air heat exchanger. The compressor may be a first compressor and a second compressor may be coupled in series with the first compressor in the first flow path. The one or more valves may be in the first flow path. An expansion device may be in the second flow path between the buffer/desiccant unit and the second heat exchange apparatus. A capillary tube distributor system may be in the second flow path. In the second mode, a flow of refrigerant along the second flow path may enter the second port and split with: a first flow portion passing through the desiccant and then through the conduit first portion to an interior of the conduit and then out the first port; and a second flow portion bypassing the desiccant and passing through the second portion of the conduit to the interior of the conduit and then out the second port. In the first mode, a flow of refrigerant along the second flow path may enter the first port and split with: a first flow portion passing through the conduit first portion and then through the desiccant and then out the first port; and a second flow portion bypassing the desiccant and passing through the second portion of the conduit and then out the second port. A greater proportion of the second mode second flow portion may pass through the distal region than of the first mode second flow portion.

At least 30% by mass flow rate of the second mode second flow portion may pass out of the distal portion whereas less than 5% by mass flow rate of the first mode second flow portion may pass out the distal region whereas less than 5% by mass flow rate of the first mode second flow portion may pass out the distal region. A refrigerant accumulation in the second mode may be greater than in the first mode by at least 20% of a total refrigerant charge. The desiccant may consist essentially of molecular sieve.

Another aspect involves a fluid filter and desiccant apparatus including a shell having first and second ports. A foraminate conduit is at least partially within the shell. A desiccant at least partially surrounds a first portion of the conduit. A pressure actuated valve is along the conduit.

In various implementations, the apparatus may have first and second partially overlapping flow paths between the first and second ports. In one flow mode, the first flow path may pass through the second port and then through the desiccant and then through the conduit first portion to an interior of the conduit and then out the first port. The second flow path may pass through the second port and then bypass the desiccant and pass through a second portion of the conduit to the interior of the conduit and then out the first port.

Another aspect involves a method performed with an apparatus. The apparatus has a first flow path between first and second heat exchange apparatus. A compressor is in the first flow path. A second flow path is between the first and second heat exchange apparatus. A buffer/desiccant unit is in the second flow path. The apparatus is run in a first mode in which refrigerant flows from the second heat exchange apparatus to the first heat exchange apparatus along the second flow path. The apparatus is run in a second mode in which refrigerant flows from the first heat exchange apparatus to the second heat exchange apparatus along the second flow path and wherein an accumulation of debris which builds up during the running of the first mode is trapped in the buffer/desiccant unit in the second mode.

In various implementations, one or more valves may be actuated to switch the apparatus from the first mode to the second mode. An accumulation of the refrigerant may build up in the buffer/desiccant unit by at least 20% of a total refrigerant charge in the second mode relative to the first mode.

Another aspect involves a refrigerant strainer for mounting in a receiver. The strainer has a conduit having an open first end and a second end, an internally threaded fitting in the second end, and an array of apertures. A pressure actuated valve is along the conduit. At least some of the apertures being to a first side of the valve and at least some being to the second side of the valve.

In various implementations, the apertures may account for 15-35% of an area of the sidewall. The conduit may be essentially circular in section with a diameter of 30-50 mm. The conduit may have a length of 0.25-2.0 m. The apertures may be essentially circular and have diameters of 0.5 1.2 mm.

Another aspect involves a refrigerant strainer and desiccant combination for mounting in a receiver The combination has a conduit having an open first end and a second end and an array of perforations in a sidewall. A desiccant surrounds a portion of the conduit. The combination includes means for trapping an accumulation of debris in a region of the conduit remote of the first end.

In various implementations, there may be means proximate the second end for registering the conduit in the receiver. The conduit length may be at least twice the desiccant length.

The details of one or more embodiments are set forth in the accompanying drawings and the description below. Other features, objects, and advantages of the invention will be apparent from the description and drawings, and from the claims.

### BRIEF DESCRIPTION OF THE DRAWINGS

FIG. 1 is a partially schematic view of a refrigeration system in a cooling mode.

FIG. 2 is a partially schematic view of the system of FIG. 1 in a heating mode.

FIG. 3 is a view of an accumulator/dryer unit of the system of FIGS. 1 and 2.

FIG. 4 is a cutaway view of the accumulator/dryer unit of FIG. 3.

FIG. 5 is a partially exploded view of a filter/dryer subassembly of the unit of FIGS. 3 and 4.

FIG. 6 is a cutaway view of an alternate accumulator/dryer unit.

FIG. 7 is a sectional view of a valve of the filter/drier subassembly in an open condition.

FIG. 8 is a sectional view of the valve of FIG. 7 in a closed condition.

Like reference numbers and designations in the various drawings indicate like elements.

### DETAILED DESCRIPTION

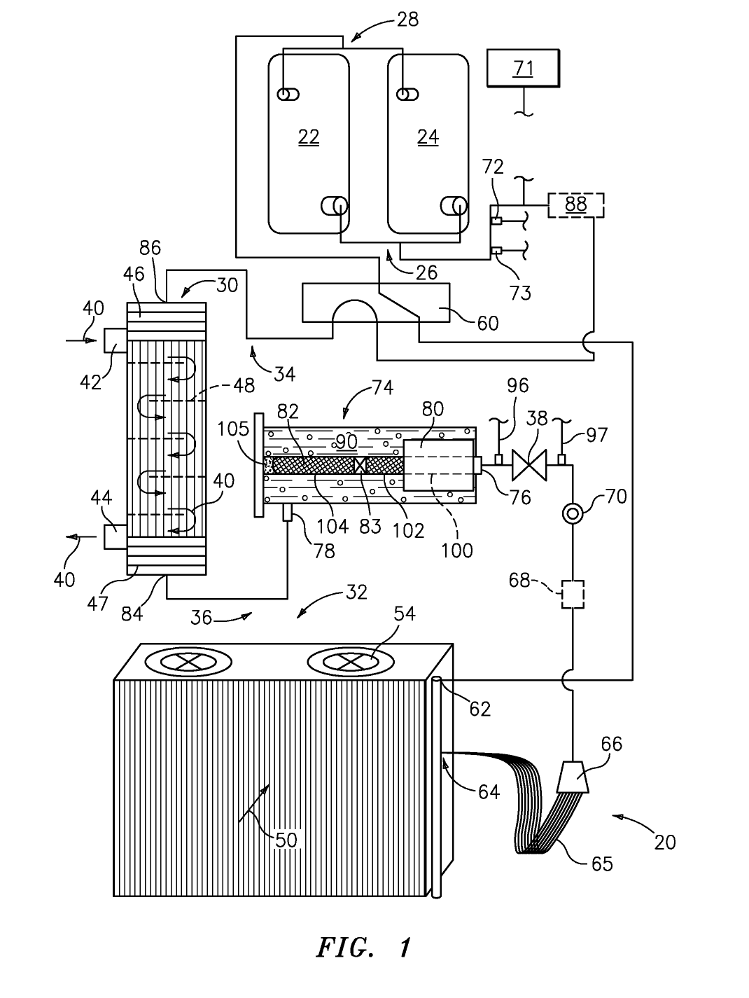

FIG. 1 shows a refrigeration system 20 operating in a cooling (e.g., chiller) mode. For purposes of illustration, the exemplary system 20 is based upon that of the '832 publication cited above. For example, the system 20 may be implemented as a remanufacturing or reengineering of such a system or its configuration. More significant/extensive reengineerings and remanufacturings are possible.

The exemplary system 20 includes exemplary first and second compressors 22 and 24 coupled in parallel to define a common inlet 26 and a common outlet 28. Single compressor systems, series compressor systems, and other compressor configurations are also appropriate. Exemplary compressors are scroll-type although other types (e.g., screw-type and reciprocating compressors) are possible.

The system 20 includes a first heat apparatus (heat exchanger) 30 and a second heat apparatus (heat exchanger) 32. Conduits and additional components define first and second flow paths 34 and 36 for passing refrigerant between the first and second heat exchangers 30 and 32. The compressors 22 and 24 are located in the first flow path 34 and an expansion device 38 is located in the second flow path 36.

In the exemplary implementation, the first heat exchanger 30 is a shell and tube heat exchanger as is typically used as an evaporator. For example, the first heat exchanger 30 may be a 2-4 refrigerant pass heat exchanger. Similarly, the second heat exchanger 32 is a fin (e.g., aluminum) and coil (e.g., copper) heat exchanger as is typically used as a condenser. In the exemplary implementation, the first heat exchanger 30 is located and coupled to exchange heat between the refrigerant and the heat exchange fluid 40 (e.g., water) entering the first heat exchanger through a water inlet 42 and exiting through a water outlet 44. The exemplary first heat exchanger 30 has tubes 45 passing the refrigerant between first and second plenums with first and second partition plates 46 and 47. Interspersed water baffles 48 define a circuitous water path between the water inlet 42 and water outlet 44.

In the cooling mode, the water 40 is chilled by the heat exchange and, upon exiting, may be directed to individual cooling units throughout the building or other facility or for other purposes. In alternative embodiments, the first heat exchanger 30 may use air or other fluid instead of water. The second heat exchanger exchanges heat between the refrigerant and an air flow 50 across the fins 52 and driven by fans 54.

In cooling mode operation, the first and second heat exchangers are used in the opposite of their normal (heating mode) roles. Compressed refrigerant exiting the outlet 28 passes through one or more valves (e.g., a four-way valve 60). As is discussed below, the valve 60 serves to shift operation between cooling and heating modes. The compressed refrigerant then enters the second heat exchanger 32 through a first port 62. In the second heat exchanger 32, the compressed refrigerant is cooled and condensed by heating the air flow 50. In the exemplary embodiment, the condensed refrigerant exits the second heat exchanger 32 through a number of second ports 64 coupled by capillary tubes 65 to a distributor manifold 66 which merges the flows from the various ports 64. The particular relevance of the distributor (formed by the capillary tubes 65 and manifold 66) is discussed below in the heating mode.

In the exemplary embodiment of the '832 publication, between the distributor manifold 66 and the expansion device 38, the condensed refrigerant passes through a first strainer 68 and a sight glass unit 70. An exemplary reengineering may remove or modify the first strainer 68 as is discussed in greater detail below. The first strainer 68 serves to protect the expansion device 38 in cooling mode operation. The sight glass 70 may be used to determine the presence or lack of bubbles in liquid refrigerant passing therethrough. For example, bubbles may evidence leaks in the system. In the cooling mode, bubbles may indicate clogging of the strainer 68 tending to increase the pressure drop across that strainer.

The condensed refrigerant is expanded in the expansion device 38. An exemplary expansion device 38 is an electronic expansion valve whose operation is controlled by a control and monitoring subsystem 71. The control and monitoring subsystem 71 may be coupled to control various system components such as the compressors 22 and 24 and four-way valve 60 and to monitor data from various sensors (not shown) such as temperature and/or pressure sensors at various locations in the system (e.g., a temperature sensor 72 and a pressure sensor 73 located along the compressor suction line 26 and used to control the opening of the electronic expansion valve based upon the refrigerant superheat temperature set point at compressor inlet conditions). Advantageously, the refrigerant is essentially in a single-phase sub-cooled liquid state from the second heat exchanger 32 to the expansion device 38. However, at least once the refrigerant pressure is reduced in the expansion device 38, the refrigerant may be in substantially a two-phase gas/liquid condition (e.g., with vapor representing 20-25% of the flow mass). The expanded two-phase refrigerant flow enters an accumulator/dryer (buffer/desiccant) unit 74 through a first port 76 and exits through a second port 78.

The exemplary accumulator/dryer unit 74 of the '832 publication includes: a desiccant core 80 for drying the refrigerant flow of water; and a strainer 82. As is discussed in greater detail below, the reeengineering or remanufacturing may add a valve 83 along the strainer 82. An exemplary valve 83 is a pressure-actuated valve (e.g., a mechanical check valve). As is discussed in greater detail below, the valve 83 is open (or at least less restrictive) when exposed to a direction of flow associated with the exemplary cooling mode. The valve 83 is closed (or at least relatively restrictive) when exposed to a pressure bias associated with an opposite flow through the unit 74 (e.g., in an exemplary heating mode discussed below).

In the exemplary cooling mode, the strainer 82 serves both as a strainer or filter and to assist in homogenization/mixing of the two phases of refrigerant (e.g., as discussed below).

After exiting through the second port 78, the dried refrigerant enters the first heat exchanger 30 through a first port 84 and is warmed by the flow of fluid 40. The refrigerant at least partially further evaporates during this heat exchange process and exits the first heat exchanger 30 through a second port 86 (e.g., as a single-phase superheated gas). In an exemplary cooling mode of the system of the '832 publication, the heated refrigerant then passes through the four-way valve 60 and through a filter 88 before returning to the compressor inlet 26. The exemplary filter 88 serves to protect the compressors in both cooling and heating modes and may be formed as an inline filter with a replaceable core (e.g. perforated stainless steel). As with the strainer 68, the reengineering or remanufacturing may remove or alter the strainer 88.

In cooling mode operation, there is an accumulation 90 of two-phase refrigerant in the accumulator/dryer unit 74. The accumulation may be of essentially constant mass during steady state operation and is continually refreshed as refrigerant exits from the accumulation to the first heat exchanger 30 downstream and enters the accumulation from the expansion device upstream.

Also, in cooling mode operation, debris/contaminants will be trapped within the strainer 82. The exemplary strainer 82 may be characterized as including a first region 100 within the core 80. A second region of the strainer is distally of the first region 100, with the valve 83 dividing the second region into a proximal region (subregion) 102 and a distal region (subregion) 104. For several reasons, there may be a bias toward accumulation of the debris 105 in a relatively downstream location (e.g., in the distal subregion 104). For example, the overall downstream flow direction within the strainer 82 will tend to shift debris that initially accumulates in the regions 100 or 102 into the region 104.

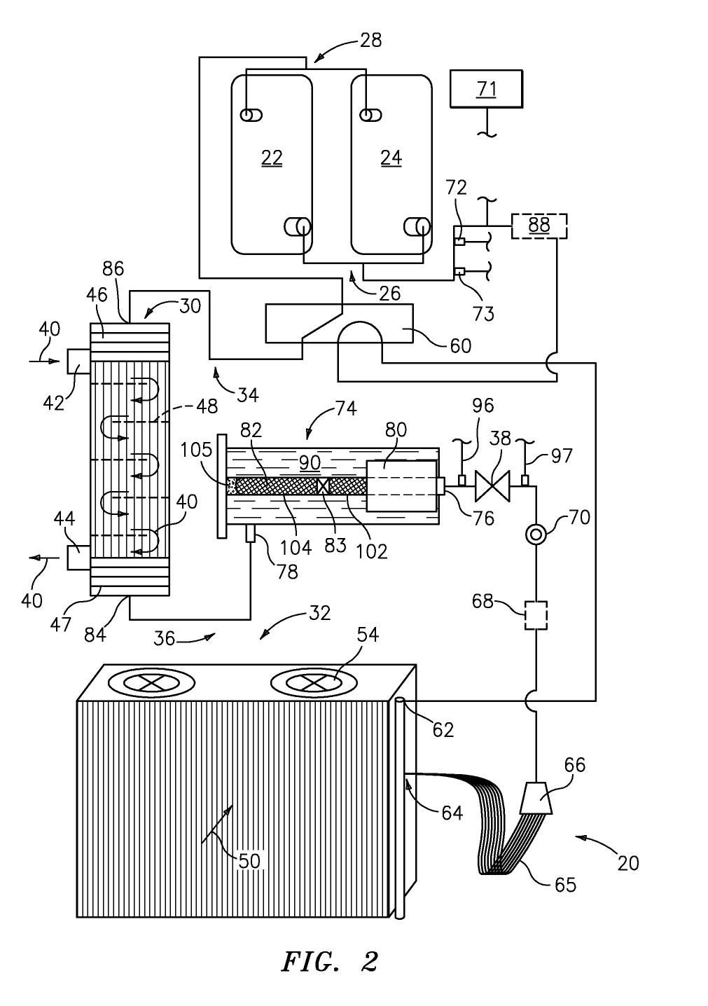

FIG. 2 shows the system 20 after the valve 60 has been actuated to place the system in the heating mode. One exemplary actuation is a linear shift (e.g., of a linearly shiftable slide element whose position is controlled by a 4-way pilot solenoid valve). An alternative exemplary actuation is via rotation (e.g., a rotary 4-way valve). In the heating mode, flow through the heat exchangers and intervening components along the second flow path 36 is reversed relative to the cooling mode. In the heating mode, the strainer 82 protects the expansion device 38 from debris originating upstream (e.g., in the first heat exchanger 30). In the heating mode, the first heat exchanger 30 serves its intended role as a condenser, condensing the refrigerant passing therethrough by giving off heat to the water 40. The second heat exchanger 32 serves its intended role as an evaporator receiving heat from the air flow 50. The refrigerant flow exiting the first heat exchanger 30 and entering the accumulator/dryer unit 74 may be essentially single-phase liquid. Accordingly, the accumulation 90 may essentially be a single-phase liquid as may be the flow entering the expansion device 38. The expanded flow exiting the expansion device 38 may be single-phase liquid or may be a two-phase flow. The distributor system formed by the manifold 66 and the capillary tubes 65 may serve a homogenizing/mixing function. Other known or yet-developed distributor systems may be used. In the heating mode, the role of the distributor system is to insure a desired phase and mass flow balance of refrigerant amongst the various tubes/coils of the second heat exchanger 32.

In the changeover from cooling to heating mode, the valve 83 will close, thereby largely trapping the debris 105 in the distal region 104. This will reduce the amount of debris that would otherwise be backflushed through the expansion device 38, second heat exchanger 32, etc. Thus, the chances of fouling or otherwise damaging other system components are reduced by the presence of the valve 83.

Due in part to the differences between the geometries and sizes of the heat exchangers 30 and 32, advantageous combined refrigerant mass contained within the two heat exchangers and other system components will differ between heating and cooling modes. The difference may also be influenced by operating conditions and by the locations, sizes, and other properties of additional system components. For example, in each mode the operating charge may be identified as the mass of refrigerant in the system excluding the accumulation in the accumulator. The operating charge for each mode may advantageously be chosen based upon performance factors. For example, it may be advantageous to maximize the energy efficiency ratio (EER) for the cooling mode and the coefficient of performance (COP) for the heating mode. In the exemplary system, more refrigerant mass may be contained in the components outside the accumulator in the cooling mode compared with the heating mode. The difference between these optimized charges may represent in excess of 20% of the cooling mode charge (e.g., 30%-40%). Accordingly, the accumulator/dryer unit 74 may be dimensioned to have sufficient excess volume to contain this difference in the heating mode.

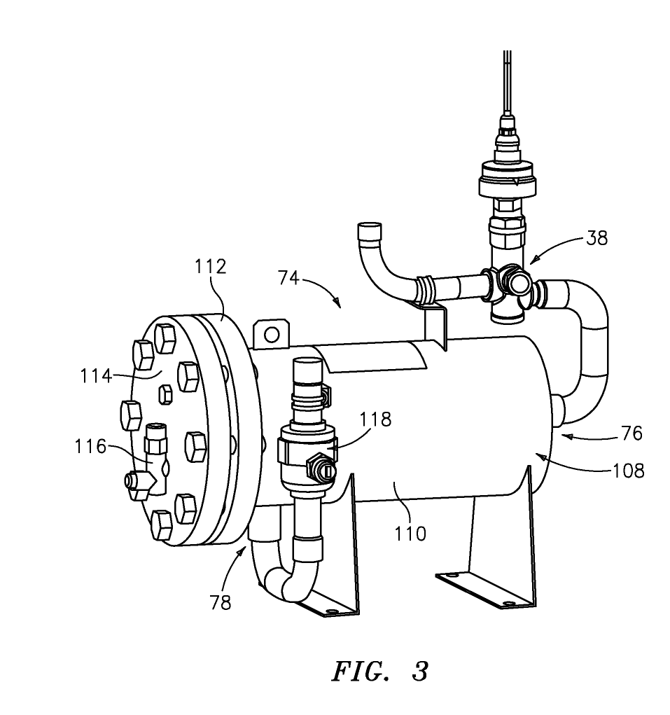

FIG. 3 shows further details of an exemplary accumulator/dryer unit 74. A vessel or unit body 108 includes a generally cylindrical shell 110 having a horizontally-oriented central longitudinal axis 500. The exemplary first port 76 is formed in an end plate at a first end of the shell and the exemplary second port 78 formed near the second end of the shell at the bottom. A flange 112 is formed at the shell second end and carries a cover 114. A service valve 116 may be provided in the cover or elsewhere to facilitate drainage during service. A ball valve 118 may be provided in the second flow path 36 between the accumulator/dryer second port 78 and the first heat exchanger first port 84. The ball valve 118 and the expansion valve 38 may be simultaneously closed for servicing of the accumulator/dryer unit 74. For example, this may be necessary to replace the core 80 with a fresh core and/or remove/clean/replace the strainer 82.

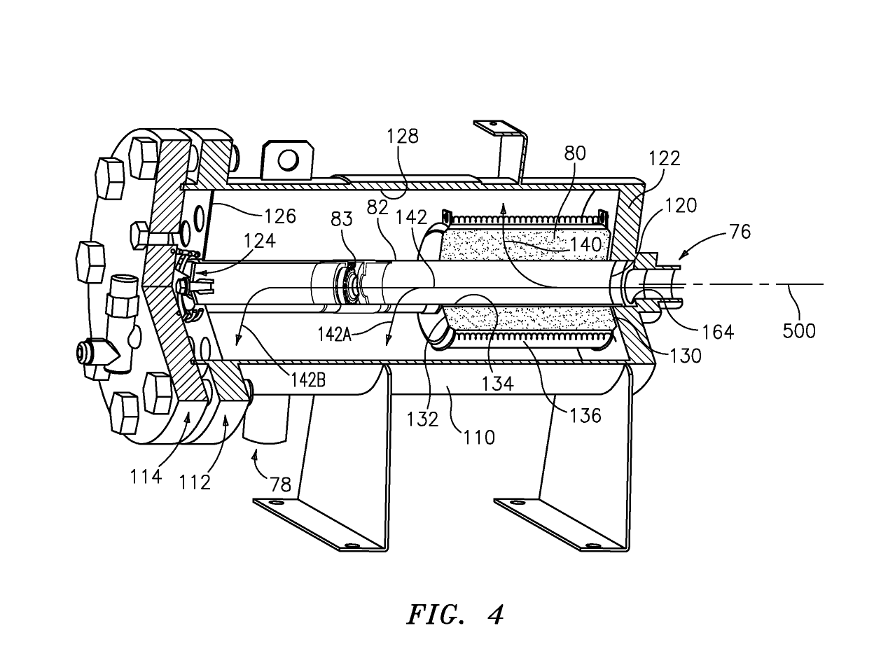

FIG. 4 shows the longitudinal axis 500 as shared with the desiccant core 80 and strainer 82. The exemplary strainer 82 is formed as an elongate perforated tube assembly extending from an open first end 120 mounted in the shell first end end plate 122 and open to the first port 76 to a closed second end 124 held by a support plate 126 spanning the shell interior surface 128 near the shell second end 124. The core 80 surrounds a first portion of the strainer 82 (e.g., near the shell first end). A second portion of the strainer is exposed within the shell interior. The core 80 is generally annular, having first and second ends 130 and 132 and inboard and outboard surfaces 134 and 136. In the cooling mode, there are two at least partially distinct flow paths through the accumulator/dryer unit 74. The two flow paths 140 and 142 overlap at the inlet 76 and diverge within the strainer 82. The first flow path 140 passes through the strainer first portion 100 and then through the core 80, passing in through the core inboard surface 134 and exiting the core outboard surface 136. The second flow path 142 splits into a first portion 142A which exits through the apertures of the strainer proximal region 102 and a second portion 142B which passes through the valve 83 and exits the apertures along the distal region 104. Outside of the core 80, the first flowpath 140 merges with the second flowpath 142 which has passed directly from the strainer interior through the strainer second portion 102. The merged flow then exits the second port 78.

Deflection of the refrigerant flow by the closed end 124 increases mixing and homogenization. Mixing and homogenization may also be aided by appropriately optimized selection of the number size and density of strainer pores. For example, if there is too high a pressure drop across the strainer, there could be liquid flashing upstream of the electronic expansion valve in the heating mode and interfering with its operation. Too high a pressure drop in the cooling mode could provide flow restriction and loss of capacity of the electronic expansion valve. Too low a pressure drop (e.g., with bigger holes) could affect filtration effectiveness. Too low a pressure drop could also affect homogenization/mixing of the two phases entering the first refrigerant pass of the evaporator providing a significant loss of capacity at the evaporator.

In heating mode operation, the flow path splits substantially in reverse directions, however, with the closed valve 83, however, blocking flow along the branch/portion 142B. Reverse flow along the branch 142A merges with reverse flow along the flow path 140. Accordingly, in the exemplary embodiment, in both modes only a portion of the flow passes through the desiccant. Advantageously, the percentage of the flow passing through the desiccant is sufficient so that, over time, an appropriate amount of water is removed from the refrigerant. An exemplary strainer 82 is formed from stainless steel tubing approximately 40 mm in diameter and 0.5 mm in wall thickness. The tubing is perforated by exemplary 0.8 mm diameter holes arranged in two sets of rings with circumferential spacing of 1.5 mm. The holes of each set of rings are out of phase with those of the other set at a stagger angle of 30° off longitudinal. The exemplary holes account for 25% of the total area of the tube (pre-perforation).

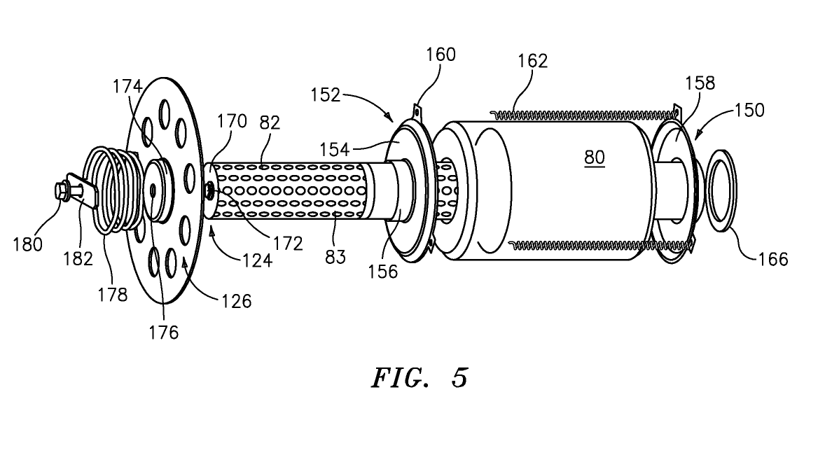

FIG. 5 shows further details of the innards of the exemplary accumulator/dryer unit 74. The core 80 is held between core first and second end plates 150 and 152 each having a web 154 extending generally radially outward from a longitudinally outward-facing sleeve 156 and having a longitudinal inboard surface 158 contoured to engage the adjacent core end. The sleeves or collars 156 have interior surfaces dimensioned to accommodate the exterior surface of the strainer 82. In the exemplary embodiment, the core end plates 150 and 152 have radially extending tabs 160 for engaging opposite ends of a plurality (e.g., three) of springs 162 to longitudinally hold the end plates and core together as a stack. The outer surface of the sleeve of the core first end plate 150 is dimensioned to be received within a bore 164 (FIG. 4) in the shell first end plate 122. A gasket 166 (FIG. 5) seals between an inboard surface of the shell first end plate 122 and an outboard surface of the web 154 of the core first end plate 150.

FIG. 5 further shows the strainer second end 124 as plugged or otherwise closed by a strainer end plate 170 (e.g., welded, brazed, or press-fit in place). The end plate 170 has an internally-threaded fitting 172. The support plate 126 has a longitudinally outwardly projecting hub 174 which concentrically receives the second end portion of the strainer 82 and has a hub end plate with a central aperture 176. A spring 178 is mounted to the outboard surface of the support plate 126 such as by means of a bolt 180 extending through a bracket 182 and through the aperture 176 into threaded engagement with the threaded fitting 172. In the exemplary embodiment, the spring 178 diverges radially outward from the support plate 126 to facilitate insertion of the bracket 182 to capture only one or more proximal end turns of the spring surrounding the hub 174. In operation, the outboard (distal) end of the spring is in compressive engagement with the inboard face of the cover 114 to bias the strainer first end into the bore 164.

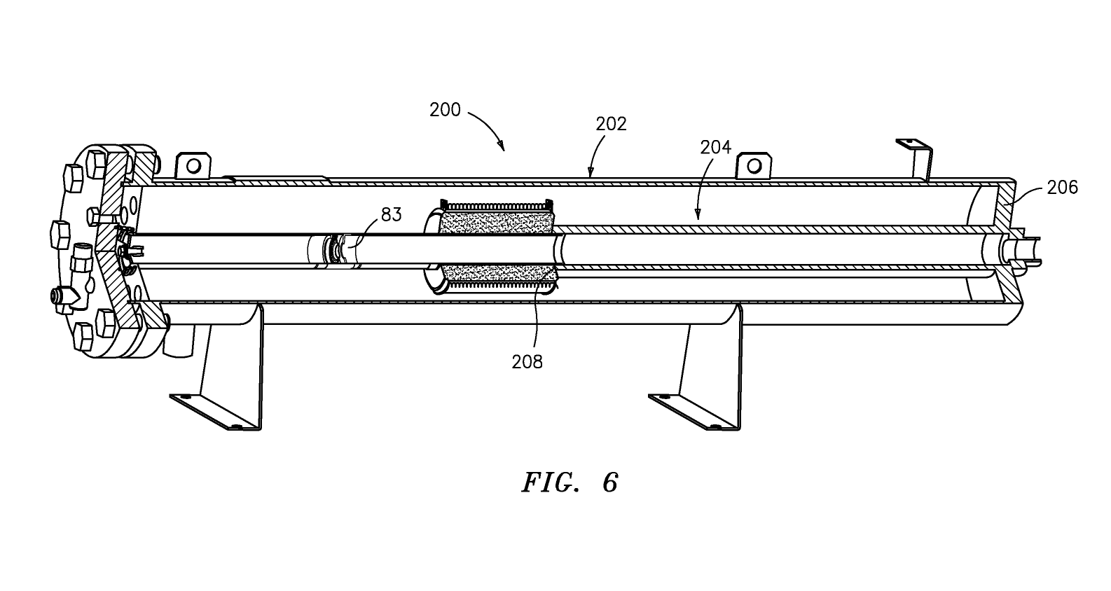

FIG. 6 shows an alternate accumulator dryer unit 200 which may be otherwise similar to the unit 74 of FIG. 3 but which has a longer shell 202 to increase internal volume to accommodate a larger charge difference. In the exemplary embodiment, the extra shell length is associated, internally, with the presence of a spacer tube 204 extending from the shell first end plate 206. The spacer tube may be unitarily or otherwise integrally formed with the end plate 206 or may be separately formed (e.g., fit into a bore similar to that of the end plate 122 of FIG. 4). In the exemplary embodiment, the spacer tube 204 has a distal end 208 having an end portion telescopically receiving the sleeve of the core first end plate 150 and having a rim engaging the gasket 166. Accordingly, the length of the spacer tube 204 may be selected to permit use of the same FIG. 5 parts as are used in the first accumulator/dryer unit 74. This permits a substantial economy of manufacturing, inventory, and the like while providing accumulators of differing capacity. Alternatively, however, other configurations offering higher accumulator volumes than the first accumulator/dryer unit 74 may be used. Some of these, too, may be configured to use identical FIG. 5 components.

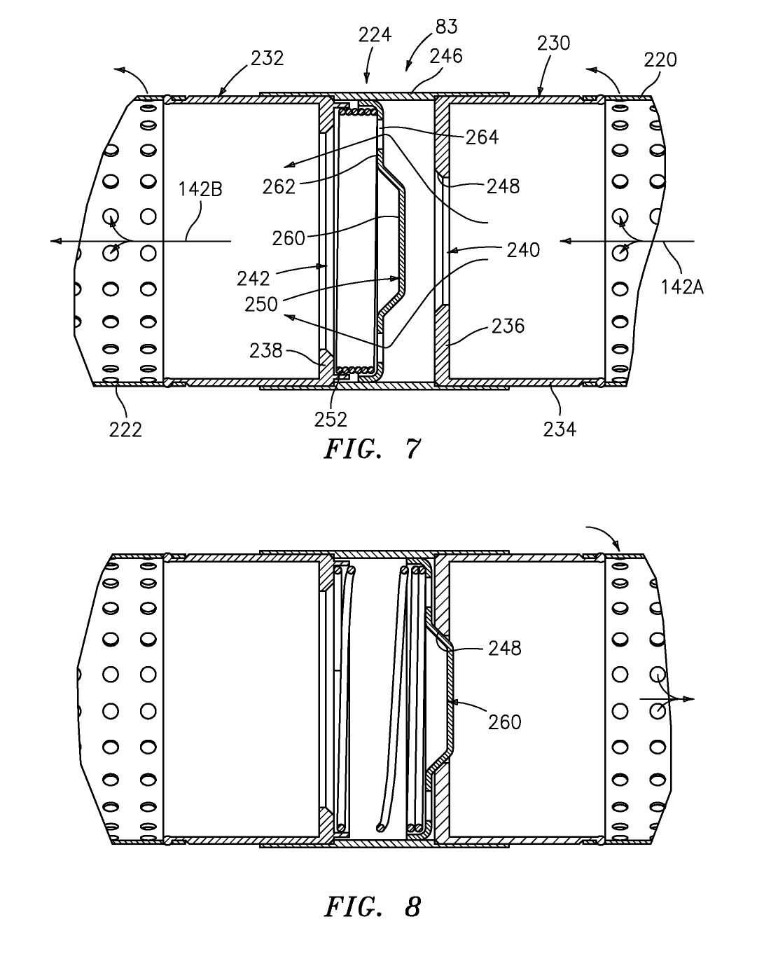

FIGS. 7 and 8 show the exemplary strainer 82 formed in two foraminate segments 220 and 222 joined end-to-end by a body 224 of the valve 83. The exemplary segment 220 includes the strainer first region 100 and proximal region 102. The segment 222 includes the distal region 104. The exemplary body 224 is an assembly of end fittings 230 and 232 secured to the segments 220 and 222 respectively at their facing ends. Each exemplary fitting 230, 232 has a sidewall 234 and an end flange 236, 238. The exemplary end flanges are annular, leaving central apertures 240, 242 as ports. The exemplary body 224 further includes a sleeve/collar 246 joining the fittings to span a gap therebetween. The flange 236 defines a valve seat 248 surrounding the aperture 240. The seat 248 and aperture 240 are sealable by valve element 250. The element 250 is pressure-shiftable from an open condition/position of FIG. 7 to a closed/sealing position/condition of FIG. 8. The exemplary valve element 250 is biased by a spring 252 (e.g., a male compression coil spring) from the open position to the closed position. The exemplary valve element 250 includes a flange having a central protruding portion 260 for sealing with the seat 248. Radially outboard of the protruding/sealing portion 250, an outer portion 262 includes a circumferential array of apertures/ports 264. The exemplary spring 250 is captured between a back surface/underside of an outboard extreme of the portion 262 on the one hand and a facing surface of the flange 258 on the other hand. The exemplary bias force of the spring 252 is light/low enough to allow the valve element to reliably shift to the open condition for the cooling mode. The spring bias is, however, sufficient to close the valve prior to substantial back flushing of debris/contaminants from the distal region 104 when the cooling mode is ceased and heating mode is begun. For example, the spring bias along with other aspects of valve geometry, port size/distribution, and the like may be effective to retain at least 90% of the mass of debris.

In an exemplary engineering process to size the accumulator/dryer unit for a given application, one may initially look to operating conditions. These include operating conditions such as the ambient environmental temperature at the second heat exchanger 32. For example, this may be a temperature of outdoor air flowing across the second heat exchanger 32. In one example, this temperature is 7 C (dry bulb; 6 C wet bulb) for the heating mode and 35 C for the cooling mode. Another parameter may be water temperature at the inlet 42. For example, this may be 40 C for the heating mode and 12 C for the cooling mode. Another parameter is desired water temperature at the outlet 44. For example, this may be 45 C for the heating mode and 7 C for the cooling mode. An experimental sizing of the accumulator/dryer may make use of temperature sensors 96 and 97 on either side of the expansion valve 38. The appropriate one of such sensors may be used to measure the degree of refrigerant subcooling immediately upstream of the expansion device 38 in each of the heating and cooling modes. The accumulator may be sized so that the active charge in the system outside the accumulator (and, in particular, the amount of refrigerant in the first heat exchanger 30) in the heating mode is effective to produce 5-6 C of subcooling. A similar amount of subcooling may be provided in the cooling mode. The total refrigerant charge or total unit charge may be selected to maximize EER in the cooling mode for the target cooling mode operating conditions. The receiver may be sized to accumulate sufficient refrigerant in the heating mod to provide a desired COP at target heating mode operating conditions. Exemplary sizing provides accumulations of 20-45% of the total refrigerant charge.

One or more embodiments have been described. Nevertheless, it will be understood that various modifications may be made. For example, when implemented as a modification of an existing system, details of the existing system may influence details of the particular implementation. Accordingly, other embodiments are within the scope of the following claims.

1. An apparatus (20) comprising:
a first heat exchange apparatus (30);
a second heat exchange apparatus (32);
a first flow path (34) between the first and second heat exchange apparatus;
a compressor (22, 24) in the first flow path;
a second flow path (36) between the first and second heat exchange apparatus;
a buffer/desiccant unit (74) in the second flow path and comprising:
a vessel (108) having a first port (76) and a second port (78);
a foraminate conduit (82) at least partially within the vessel;
a desiccant (80) at least partially surrounding a first portion (100) of the conduit; and
a pressure-actuated valve (83) along a second portion of the conduit; and
at least one valve (60) positioned to switch the apparatus between:
a first mode in which refrigerant flows from the second heat exchange apparatus (32) to the first heat exchange apparatus (30) along the second flow path (36); and
a second mode in which refrigerant flows from the first heat exchange apparatus (30) to the second heat exchange apparatus (32) along the second flow path (36).

2. The apparatus of claim 1 wherein:
the first heat exchange apparatus (30) is a refrigerant-to-water heat exchanger; and
the second heat exchange apparatus (32) is a refrigerant-to-air heat exchanger.

3. The apparatus of claim 1 wherein:
the compressor is a first compressor (22, 24);
a second compressor (24, 22) is coupled in series with the first compressor in the first flow path (34); and
the at least one valve (60) is in the first flow path (34).

4. The apparatus of claim 1 further comprising:
an expansion device (38) in the second flow path between the buffer/desiccant unit (74) and the second heat exchange apparatus (32).

5. The apparatus of claim 4 further comprising:
a capillary tube distributor system (66) in the second flow path (36).

6. The apparatus of claim 1 wherein:
the pressure-actuated valve (83) separates a distal region (104) of the second portion from a proximal region (102) of the second portion; and
the pressure-actuated valve (83) is positioned to restrict flow from the distal region (104) to the proximal region (102) relative to flow from the proximal region to the distal region.

7. The apparatus of claim 6 wherein:
in the second mode, a flow of the refrigerant along the second flow path (36) enters the second port (78) and splits with:
a first flow portion passing through the desiccant (80) and then through the conduit first portion (100) to an interior of the conduit and then out the first port (76); and
a second flow portion bypassing the desiccant and passing through the second portion of the conduit to the interior of the conduit and then out the first port; and
in the first mode, a flow of the refrigerant along the second flow path enters the first port (76) and splits with:
a first flow portion passing through the conduit first portion (100) and then through the desiccant (80) and then out the second port; and
a second flow portion bypassing the desiccant and passing out the second portion of the conduit and then out the second port, a greater proportion of the second mode second flow portion passing through the distal region than of the first mode second flow portion.

8. The apparatus of claim 7 wherein:
at least 30% by mass flow rate of the second mode second flow portion passes out the distal region (104); and
less than 5% by mass flow rate of the first mode second flow portion passes out the distal region.

9. The apparatus of claim 7 wherein:
a refrigerant accumulation in the second mode is greater than in the first mode by at least 20% of a total refrigerant charge.

10. The apparatus of claim 1 wherein:
the desiccant consists essentially of a molecular sieve.

11. The apparatus of claim 1 wherein:
said compressor is a first compressor in parallel with a second compressor.

12. A fluid filter and desiccant apparatus (74) comprising:
a vessel (108) having first (76) and second (78) ports;
a foraminate conduit (82) at least partially within the vessel;
a desiccant (80) at least partially surrounding a first portion (100) of the conduit; and
a pressure-actuated valve (83) along the conduit.

13. The apparatus of claim 12 having first and second partially overlapping flow paths between the first and second ports wherein in one flow mode:
the first flow path (140) passes through the second port (78) and then through the desiccant (80) and then through the conduit first portion (100) to an interior of the conduit and then out the first port (76); and
the second flow path (142) passes through the second port and then bypasses the desiccant and passes through a second portion of the conduit to the interior of the conduit and then out the first port.

14. The apparatus of claim 12 wherein:
the foraminate conduit comprises a perforated metallic tube of circular section

15. The apparatus of claim 12 wherein:
the desiccant comprises a molecular sieve.

16. With an apparatus comprising:
a first flow path (34) between a first heat exchange apparatus (30) and a second heat exchange apparatus (32);
a compressor (22, 24) in the first flow path;
a second flow path (36) between the first and second heat exchange apparatus; and
a buffer/desiccant unit (74) in the second flow path (36), a method for operating said apparatus comprising:
running the apparatus in a first mode in which a refrigerant flows from the second heat exchange apparatus to the first heat exchange apparatus along the second flow path; and
running the apparatus in a second mode in which said refrigerant flows from the first heat exchange apparatus to the second heat exchange apparatus along the second flow path and wherein an accumulation of debris which builds up during the running in the first mode is trapped in the buffer/desiccant unit in the second mode.

17. The method of claim 16 further comprising:
actuating at least one valve to switch the apparatus from said first mode to said second mode.

18. The method of claim 16 wherein a refrigerant accumulation builds up by at least 20% of a total refrigerant charge in the second mode relative to the first.

19.-23. (canceled)
